(19) United States
(12) Patent Application Publication
(10) Pub. No.: US 2005/0119431 A1
(43) Pub. Date: Jun. 2, 2005

(54) Novel cationic polymers containing amidinium groups and their use

(76) Inventor: Friedrich Georg Schmidt, Haltern am See (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/508,449

(22) PCT Filed: Feb. 20, 2003
(86) PCT No.: PCT/EP03/01706

(30) Foreign Application Priority Data
Apr. 4, 2002 (DE) 10214873.2

(51) Int. Cl. C08F 26/06

(52) U.S. Cl. 526/258

(57) ABSTRACT

Cationic polymers comprising cyclic nonaromatic units which contain an amidinium group, with the cyclic nonaromatic units which contain an amidinium group being located (i) in the main chain of the polymer or (ii) in the side chains of the polymer, where in this case the polymer is neither a vinyl polymer, a polyglycoside or a polyorganosiloxane, or (iii) both in the main chain and in the side chains, and their preparation and use are described.

The present invention relates to cationic polymers comprising cyclic nonaromatic units which contain an amidinium group, their preparation and their various possible uses, in particular as polymer electrolytes.

For some years now, ionic liquids have been the subject of various research studies. In general terms, an an ionic liquid is a liquid which consists exclusively of ions. To differentiate them from a classical salt melt which is usually a high-melting, highly viscous and usually very corrosive medium, ionic liquids are liquid at low temperatures (<100° C.) and have a relatively low viscosity. Even though there are some examples of the successful use of high-temperature salt melts as reaction media in preparative applications, the fact that ionic liquids are in a liquid state below 100° C. has for the first time made it possible for them to be used as replacement for conventional organic solvents in chemical processes. Although ionic liquids have been known since 1914, they have been studied intensively as solvents and/or catalysts in organic syntheses only in the last 10 years.

Both for use as solvent for catalytic reactions and for other applications, it can be advantageous to immobilize the ionic liquid. The advantages of immobilization in catalytic syntheses are the increased ease of separating off, recovering and regenerating the catalyst and decreased product contamination.

Immobilized ionic liquids are known, for example, from EP-A-0 553 009 and U.S. Pat. No.5,693,585. Both references describe a calcined support which has immobilized on it an ionic liquid comprising aluminum chloride and an alkylated ammonium chloride or imidazolinium chloride. The immobilized ionic liquids are used as catalysts in alkylation reactions.

WO-A-01/32308 describes ionic liquids which are immobilized on a functionalized support which bears or contains a component of the ionic liquid or a precursor of such a component. The ionic liquid can be immobilized via the anion by treating a support with an anion source before the ionic liquid is applied or formed. Alternatively, the ionic liquid can be immobilized by the cation being covalently bound to the support or incorporated in the support. The immobilized ionic liquids are used as catalysts, e.g. for the Friedel-Crafts reaction.

The work of N. Ogata, K. Sanui, M. Rikukawa, S. Yamada and M. Watanabe (Synthetic Metals 69 (1995), pages 521-524, and Mat. Res. Soc. Symp. Proc. volume 293, page 135 ff.) has also been concerned with “immobilized” ionic liquids, specifically new polymer electrolytes which are in the form of ion-conducting polymer complexes and are formed by dissolution of various polycationic salts in ionic liquids (here also referred to as “salt melts”) comprising aluminum chloride. The polycationic salts can be polyammonium, polypyridinium, polysulfonium and/or polyphosphonium salts. A polymer complex comprising a polypyridinium salt as ionic liquid and a pyridinium salt and aluminum chloride were investigated in detail. In this case, the polypyridinium salt instead of the pyridinium salt is the ionic liquid and makes it possible for the polymer complexes to form thin layers as a result of the tremendous increase in the viscosity compared to the pure ionic liquid. The new polymer complexes have a high ionic conductivity and, like other polymer electrolytes, are of interest for use in batteries and displays.

U.S. Pat. No. 6,025,457 discloses polyelectrolytes of the “salt melt type” which comprise a polymer of the salt melt type which is obtained by reaction of an imidazolium derivative bearing a substituent in the 1- and 3-position with at least one organic acid or an organic acid compound having an acid amide or acid imide bond, with at least one component, i.e. said imidazolium derivative or said organic acid compound, being a polymerizable monomer or a polymer. These polyelectrolytes, too, display high ionic conductivity at room temperature and have good chemical properties.

Cationic polymers containing imidazolium groups are also known from the prior art for other applications.

Thus, DE-A-30 36 437 describes cationic emulsions which have been prepared by emulsion polymerization of an ethylenically unsaturated monomer in the presence of a polyvinyl alcohol modified with cationic groups. The cationically modified polyvinyl alcohol can contain, for example, imidazolium groups in the side chain.

DE-A-22 08 895 relates to a process for preparing aqueous polymer dispersions in which N-vinylimidazolium salts can be used as comonomers.

Apart from cationic polymers which bear aromatic imidazolium groups, polymers having amidinium groups in an unsaturated heterocycle are also known from the prior art.

Thus, T. Seckin, B. Alici, E. Qetinkaya, I. Özdemir in Polymer Bulletin 37, pages 443-450 (1996) report studies on the synthesis and free-radical polymerization of new vinyl monomers containing imidazolinium and tetrahydropyrimidinium groups. . 1,1′-dimethylene-3,3′-di(vinylbenzyl)imidazolinium dichloride, 1,1′-trimethylene-3,3′-di(vinylbenzyl)imidazolium dichloride, 1,1′-dimethylene-3,3′-di(vinylbenzyl)-1,4,5,6-tetrahydropyrimidinium dichloride or 1,1′-trimethylene-3,3′-di(vinylbenzyl)-1,4,5,6-tetrahydropyrimidinium dichloride as active species was polymerized with styrene or with styrene and divinylbenzene. The soluble and insoluble vinyl polymers obtained in this way, which contained 2-imidazolinium and 1,4,5,6-tetrahydropyrimidinium groups, displayed antibacterial properties against Escherichia coli.

WO-A-94/01077 relates to an aqueous hair treatment product which comprises a combination of cationic and amphoteric or zwitterionic polymers, with the cationic polymers containing imidazolinium groups. The cationic polymers are preferably vinyl polymers, but it is also possible to use cationic polymers in which the main polymer chain is built up of, for example, glycosides. The imidazolinium groups are introduced into the cationic polymer by using imidazolinium systems comprising at least the polymerizable group, i.e. preferably the vinyl group, as substituent as monomers, if desired together with further comonomers.

In Polymer, volume 39, No. 23 (1998), pages 5643-5648, S.-M. Deng and X. Li report the formation of polyelectrolyte complexes of a polyorganosiloxane containing imidazolinium groups in the side chains with poly(sodium styrenesulfonate). The polyelectrolytic complexes are formed by electrostatic interaction of the oppositely charged polyelectrolytes, i.e. the polycation and the polyanion. Polyelectrolyte complexes are generally used in the fields of medicine, pharmacy, semipermeable membrane technology and electrographic printing.

It is an object of the present invention to provide a novel cationic polymer which is suitable, in particular, for preparing ion-conducting polymer complexes. It has now been found that this object is achieved by a cationic polymer comprising cyclic nonaromatic units which contain an amidinium group, with the cyclic nonaromatic units which contain an amidinium group being located
(i) in the main chain of the polymer or
(ii) in the side chains of the polymer, where in this case the polymer is neither a vinyl polymer, a polyglycoside or a polyorgano-siloxane, or
(iii) both in the main chain and in the side chains.

The cyclic nonaromatic units which contain an amidinium group are preferably substituted or unsubstituted 5-, 6- or 7-membered rings, particularly preferably substituted or unsubstituted imidazolinium, tetrahydropyrimidinium and tetrahydro-1,3-diazepinium groups, with imidazolinium and tetrahydropyrimidinium groups being most preferred. The cyclic nonaromatic units can also be 8-membered or larger rings.

In a preferred embodiment of the cationic polymer, the cyclic nonaromatic units which contain an amidinium group are located in the main chain of the polymer. They can then be linked to the main chain via C or N atoms of the cyclic unit. The cyclic nonaromatic units which contain an amidinium group are preferably linked to the main chain of the polymer via the two N atoms. A particularly advantageous cationic polymer is one having the following structural unit in the main chain: 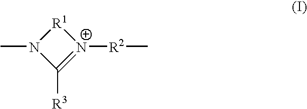
where R¹ is —(CH₂)ₙ— where n=2, 3 or 4, preferably 2 or 3; R² is —(CH₂)m— where 0<m<22, —CH═CH—CH₂—, —CH═CH—CH₂—CH₂—, —CH═CH—, —CH═CH—CH═CH—, a monocyclic or polycyclic arylene radical or a divalent polyether radical of the structure —(CH₂)ₖ—(O—(CH₂)ₖ)ₚ— where 0<k<22 and 0<p<100, in particular R²═R¹; and R³ is —(CH₂)₁—CH₃ where 0<I<21 or a monocyclic or polycyclic aryl radical.

Particular preference is given to n being 2, i.e. the cyclic nonaromatic units which contain an amidinium group are preferably imidazolinium groups.

Alternatively, the cyclic nonaromatic units which contain an amidinium group may be present in the side chains of the polymer. The type of polymer, i.e. the structure of the main chain, is in this case not relevant for the purposes of the invention. Illustrative examples of polymer skeletons having side chains in which the cyclic nonaromatic units which contain an amidinium group are present are polyethers, polyesters, polyamides and polyurethanes. The main chain can naturally also be made up of a variety of structural units, so that the polymer is a corresponding copolymer.

The cyclic nonaromatic units which contain an amidinium group and are located in the side chains of the polymer can, for example, have the following structures: 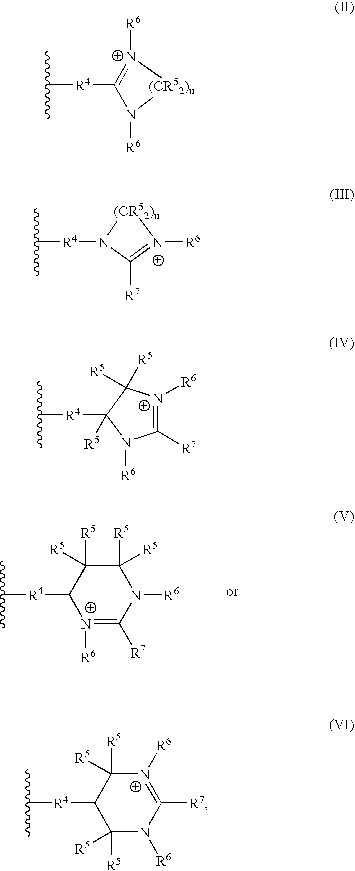
where u=2, 3 or 4 preferably 2 or 3;
R⁴ is selected from among —(CH₂)ᵣ— where 0<r<22, —(CH₂)ₛ—(O—(CH₂)ₛ)ₜ— where 0<s<22 and 0<t<100 and —CO—Y—(CH₂)ᵤ— where Y═O, NH and 1<u<23;
R⁵ is selected from among H, —CH₃—, —C₂H₅, —C₃H₇ and —C₄H₉ and may be identical or different within a unit;
R⁶ is an unbranched or branched alkyl radical having from 1 to 18 carbon atoms and may be identical or different within a unit;
and R⁷ is H or R⁶.

Cationic polymers which comprise different cyclic nonaromatic units containing an amidinium group are also encompassed by the present invention.

The weight average molecular weight of the cationic polymer of the invention is, in a preferred embodiment, from 500 to 1 500 000, more preferably from 500 to 200 000 and most preferably from 20 000 to 50 000.

The counterion of the cationic polymer of the invention can be any anion which does not react with the cationic polymer; mixtures of various anions are also suitable. Examples of suitable anions include halide, i.e. chloride, bromide and iodide, preferably iodide;. phosphate; halophosphates, preferably hexafluorophosphate; alkyl phosphates; nitrate; sulfate; hydrogensulfate; alkyl sulfates; aryl sulfates; perfluorinated aryl and alkyl sulfates, preferably octyl sulfate; sulfonate, alkylsulfonates; arylsulfonates; perfluorinated arylsulfonates and alkylsulfonates, preferably triflate; perchlorate; tetrachloroaluminate; tetrafluoroborate; alkyl borates, preferably B(C₂H₅)₃C₆H₁₃⁻, tosylate; saccharinate; alkyl carboxylates and bis(perfluoroalkylsulfonyl)amide anions, preferably the bis(trifluoromethylsulfonyl)amide anion.

The most preferred counterions are iodide, hexafluorophosphate, alkyl sulfates, in particular octyl sulfate, tetrafluoroborate and the bis(trifluoromethylsulfonyl)amide anion.

In a preferred embodiment, the counterion can be an anion which is suitable for producing liquid-crystalline states, for example an anion of the formula 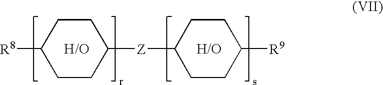
where H/O means that the rings can, independently of one another, be aromatic or saturated;
r and s are each, independently of one another, 0, 1 or 2 and r+s≧2;
z is a single bond, —C₂H₂—, —C₂H₅—, —CF₂O—, —OCF₂—, 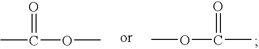
R⁸ and R⁹ are each, independently of one another, an unsubstituted alkyl radical having up to 15 carbon atoms, an alkyl radical which has up to 15 carbon atoms and is monosubstituted by —CN or CF₃ or is monosubstituted or polysubstituted by halogen, where one or more —CH₂— groups in these radicals may be replaced, independently of one another, by —O—, —S—, —C—≡C—, —C—O—, 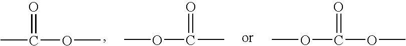
   in such a way that O atoms are not directly bound to one another, with the proviso that at least one of the radicals R⁸ or R⁹ bears a functional group —COO⁻ or —SO₃ ⁻, e.g.:

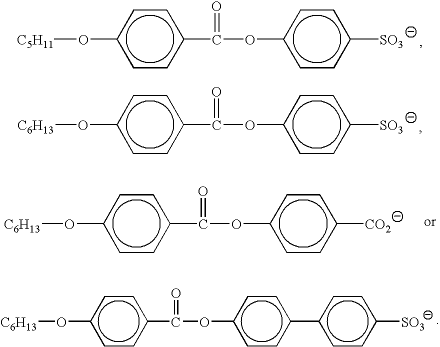

Novel liquid-crystalline polymers are obtained in this way.

A preferred anion capable of forming liquid crystal phases has the following formula: 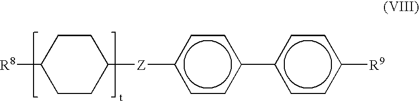
where t=1 or 2 and R⁸, R⁹ are z are as defined above, e.g.

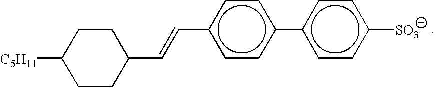

The novel cationic polymers comprising cyclic nonaromatic units which contain an amidinium group can be prepared by various methods. Apart from the use of a monomer which comprises the cyclic nonaromatic units which contain an amidinium group or a nonquaternized amidine group in the polymerization reaction, which leads to polymers having the cationic amidinium groups in the side chains, it is also possible to introduce the cyclic nonaromatic units which contain an amidinium group only after the actual polymerization reaction.

A suitable method of producing imidazolinium, tetrahydropyrimidinium and tetrahydro-1,3-diazepinium rings is, for example, reaction of an ortho ester with the appropriate N,N′-dialkyl-α,ω-alkanediamine in the presence of a suitable ammonium compound, e.g. ammonium tetrafluoroborate or ammonium hexafluorophosphate. The synthesis of the corresponding monomeric cyclic amidinium tetrafluoroborates and hexafluorophosphates has been described by S. Saba, A. Brescia and M. K. Kaloustian in Tetrahedron Letters, volume 32, No. 38, pages 5031-5034 (1991). The cationic polymers of the invention comprising the above-described structural units can be prepared by means of analogous reactions.

To introduce a cyclic amidinium group into a side chain of the polymer, it is possible either to start out from a polymer which bears an ortho ester group, preferably an ethyl ortho ester group, in the side chain and react this with an N,N′-dialkyl-α,ω-alkanediamine, e.g. as in the preparation of a polymer having a side chain of the structure (II) as shown in the following scheme (i) 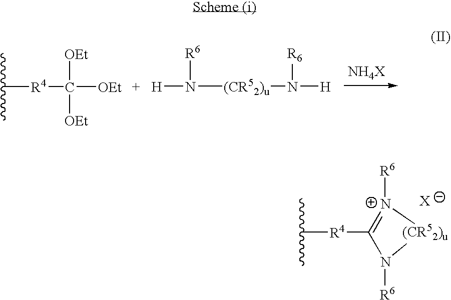
or to start out from a polymer which bears the diamine function in the side chain and react this with an ortho ester, once again preferably an ethyl ortho ester, e.g. as in preparation of a polymer having a side chain of the structure (Ill) as shown in the following scheme (ii):

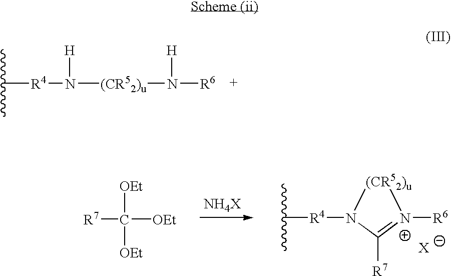

In the two reaction schemes (i) and (ii), R⁴, R⁵, R⁶, R⁷ and u are defined as for the structures (II) and (III); Et is the ethyl radical and X⁻ is a weakly nucleophilic anion, for example tetrafluoroborate or hexafluorophosphate. A person skilled in the art will readily be able to see how polymers having side chains of the structures (IV), (V), (VI) or other structures within the scope of the present invention can be prepared by analogous reactions using appropriately chosen starting compounds.

Polymers having imidazolinium, tetrahydropyrimidinium and tetrahydro-1,3-diazepinium groups in the main chain can also be prepared via the reaction with an ortho ester. Thus, for example, the reaction of linear or predominantly linear polyethylenamine with an ortho ester in accordance with the following scheme (iii) 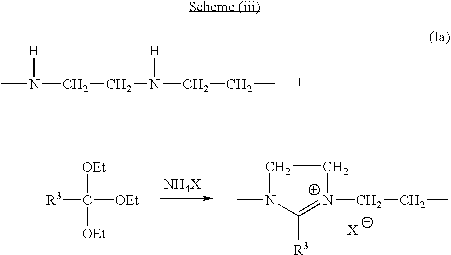
leads to a cationic polymer having imidazolinium groups in the main chain, where Et and X⁻ in the above scheme (iii) are as defined above and the imidazolinium groups are linked to the main chain via N atoms. The structural unit (Ia) produced in this way is a specific example of the more general structural unit (I) described above in which R¹ is —CH₂)ₙ—where n=2 and R² is R¹. In scheme (iii) above, R³ is defined as for the structural unit (I).

If the polyethylenamine used contains long-chain branches analogous to the starting polymer shown in scheme (ii), reaction with an ortho ester in accordance with scheme (ii) and (iii) gives a polymer which has imidazolinium groups both in the main chain and in the side chains.

Polymers in which the cyclic nonaromatic units are located in the main chain and are linked to it via C atoms can likewise be prepared by reaction with an ortho ester. Thus, for example, the reaction of polyvinylamine with an orth ester, preferably an ethyl ortho ester, as shown in scheme (iv) leads to a cationic polymer having tetrahydropyrimidinium groups in the main chain.

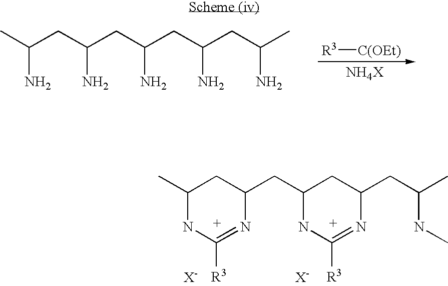

Analogously, the reaction of polyallylamine with an ortho ester, preferably an ethyl ortho ester, as shown in scheme (v) leads to formation of 8- membered rings in the main chain.

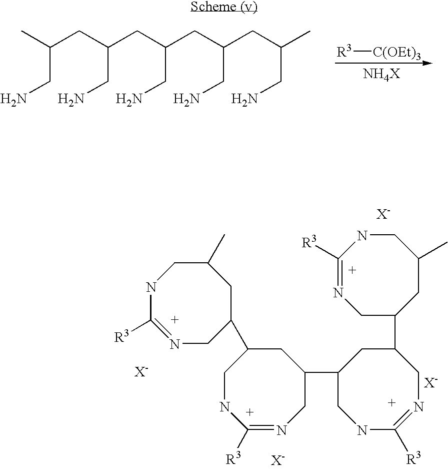

In both schemes, R³ is as defined for structural unit (I).

The anions X⁻ introduced in the synthesis using ortho esters can later be replaced by other desired counterions.

Depending on the type of anion and depending on the molecular weight and structure of the polymer skeleton, the polymers of the invention can be in different physical states ranging from liquid via soft, gel-like, vitreous, hard to partially crystalline. The ion density and the type of anions and also the hydrophilicity of the polymer influence, inter alia, the electrical properties, e.g. the ionic conductivity and the specific volume resistance.

Depending on their specific properties, the polymers of the invention are used as solid or gel-like polyelectrolytes in batteries and solar cells; as ion-conducting adhesives having adjustable thermal and electrical properties; as coatings having, for example, a biocidal and/or antistatic action or antiblocking properties, for instance for natural or synthetic fibers, woven fabrics, knitteds, nonwovens, meshes or mats made of natural or synthetic fibers or for sheets and films; as coatings for small particles for improving their dispersibility and/or their electrophoretic mobility; as miscible or self-demixing additives for polymers, for example for modifying the viscosity and/or conductivity; and for optical components having adjustable optical properties (e.g. index of refraction).

A significant advantage of the novel cationic polymers is, however, their compatibility with many ionic liquids so that ion-conducting polymer complexes can be formed in this way. For example, the ionic liquid is a salt made up of a cation selected from among imidazolium ions, pyridinium ions, ammonium ions and phosphonium ions of the following structures 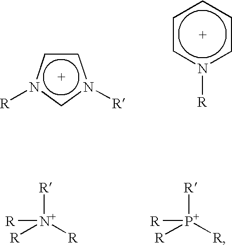
where R and R′ are each, independently of one another, H or an alkyl, olefin or aryl group, or from among substituted and unsubstituted imidazolinium, tetrahydropyrimidinium and tetrahydro-1,3-diazepinium ions and an anion selected from the group consisting of halides, i.e. chloride, bromide and iodide, preferably iodide; phosphate; halophosphates, preferably hexafluorophosphate; alkyl phosphates; nitrate; sulfate; hydrogensulfate; alkyl sulfates, preferably octyl sulfate; aryl sulfates; perfluorinated aryl and alkyl sulfates; sulfonate, alkylsulfonates; arylsulphonates; perfluorinated arylsulfonates and alkylsulfonates, preferably triflate; perchlorate; tetrachloroaluminate; tetrafluoroborate; alkyl borates, preferably B(C₂H₅)₃C₆H₁₃⁻; tosylate; saccharinate; alkyl carboxylates and bis(perfluoroalkylsulfonyl)amide anions, preferably the bis(trifluoromethylsulfonyl)amide anion, or a mixture of a plurality of such salts. Particularly good compatibility with ionic liquids is observed when the latter have not only the same anion as the cationic polymer but the structure of the cations of the ionic liquid also corresponds to the cationic units of the polymer of the invention.

In addition to the uses described above for the cationic polymer, the resulting polymer complexes are employed in many further areas, e.g. as membrane constituents; as solvents having complexing and/or stabilizing effects, e.g. for catalytic reactions; as separation materials in gas and liquid separations, e.g. in chromatographic methods for analytical and preparative purposes; and in various optical applications in which specific matching of the index of refraction of the materials used is necessary.

In an embodiment of the invention which has already been mentioned, ionic bonding of the cationic polymer to anions which form liquid crystal phases gives novel liquid-crystalline polymers which can be employed in electrooptic components, e.g. in displays. The combination of these liquid-crystalline polymers with ionic liquids also makes possible the simple production of thin layers and the adjustment of optical and thermal properties.

1. A cationic polymer comprising cyclic nonaromatic units which comprise an amidinium group, with the cyclic nonaromatic units which comprise an amidinium group located in the main chain of the polymer, wherein the cyclic nonaromatic units which comprise an amidinium group are linked to the main chain of the polymer via the two N atoms.

2. The cationic polymer as claimed in claim 1, wherein the cyclic nonaromatic units which comprise an amidinium group are substituted or unsubstituted 5-, 6- or 7-membered rings or combinations thereof.

3. The cationic polymer as claimed in claim 2, wherein the cyclic nonaromatic units which comprise an amidinium group are selected from the group consisting of substituted and unsubstituted imidazolinium, tetrahydropyrimidinium tetrahydro-1,3-diazepinium groups and combinations thereof.

4. The cationic polymer as claimed in claim 1 which comprises the following structural unit in the main chain: 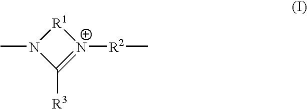
wherein R¹ is —(CH₂)ₙ— where n=2, 3 or 4;
R² is —(CH₂)ₘ— where 0<m<22,
—CH═CH—CH₂—,
—CH═CH—CH₂—CH₂—,
—CH═CH—,
—CH═CH—CH=CH—,
a monocyclic or polycyclic arylene radical or
a divalent polyether radical of the structure —(CH₂)ₖ—(O—(CH₂)ₖ)ₚ— where 0<k<22 and 0<p<100, ; and
R³ is —(CH₂)₁—CH₃ where 0<1<21 or a monocyclic or polycyclic aryl radical.

5. The cationic polymer as claimed in claim 4, wherein n=2 and R²═R¹ and the cationic polymer is prepared from essentially linear polyethylenamine.

6. The cationic polymer as claimed in claim 1 comprising at least one counterion selected from the group consisting of iodide, halide, phosphate, halophosphates, alkyl phosphates, nitrate, sulfate, hydrogensulfate, alkyl sulfates, aryl sulfates, perfluorinated alkyl and aryl sulfates, sulfonate, alkylsulfonates, arylsulfonates, perfluorinated alkylsulfonates and arylsulfonates, perchlorate, tetrachloroaluminate, tetrafluoroborate, alkyl borates, tosylate, saccharinate, alkyl carboxylates, bis(perfluoroalkylsulfonyl)amide anions and mixtures thereof.

7. The cationic polymer as claimed in claim 6 wherein the counterion is iodide.

8. The cationic polymer as claimed in claim 1 which comprises at least one counterion capable of producing liquid-crystalline states.

9. A process for preparing the cationic polymer as claimed in claim 4 comprising reacting a predominantly linear polyethylenamine with an ortho ester in the presence of an ammonium salt which comprises weakly nucleophilic anion wherein R¹═R²═—CH₂—CH₂—.

10. A polyelectrolyte comprising the cationic polymer as claimed in claim 1, wherein the polvelectrolyte is comprised in a battery or a solar cell.

11. An additive for polymers comprising the cationic polymer as claimed in claim 1.

12. An optical component comprising the cationic polymer as claimed in claim 1.
